(19) United States
(12) Patent Application Publication
(10) Pub. No.: US 2010/0061182 A1
(43) Pub. Date: Mar. 11, 2010

(54) Device for stirring and dosing liquids as well as stirring rod

(76) Inventors: Alfred Gohring, Salem (DE); Thomas Jeltsch, Friedrichshafen (DE); Christoph Welte, Ueberlingen (DE)

Correspondence Address: Scott R. Foster;Pandiscio & Pandiscio, P.C., 470 Totten Pond Road, Waltham, MA, 02451, US

(21) Appl. No.: 12/583,489

(22) Filed: Aug. 21, 2009

(30) Foreign Application Priority Data
Sep. 11, 2008 (EP) 08015983.3

(51) Int. Cl. B01F 15/04

(52) U.S. Cl. 366/162.2

(57) ABSTRACT

In a device (1) for stirring and for dosing the mixing ratio of different kinds of liquid (2), in particular of paints (3) and a thinning agent (4), consisting of a stirring rod (6) and a reservoir container (5) in which the liquids to be mixed together are filled, it should be possible to measure the amount of liquid (2) to be added in relation to the amount of fluid (2) already contained, and to do so in a quick and easy manner using the stirring rod (6).

This is achieved in that the stirring rod (6) has got at least two measuring openings (11) worked into it, which are spaced apart in the direction of the lengthways axis (7) of the stirring rod (6), and that the dimension of the particular measuring opening (11) measured parallel to the lengthways axis (7), and the measuring web (12) remaining between two adjacent measuring openings (11), are configured in relation to the fill level of the liquids (2) that are put into the reservoir container (5), or at least one jacket surface of the stirring rod (6) has got one or more measuring bodies (13) formed on it, which are spaced at intervals from one another in the direction of the lengthways axis (7) of the stirring rod (6) and in relation to the fill level in the reservoir container (5), and that the dimension of the measuring bodies (13) running in the direction of the lengthways axis (7) of the stirring rod (6) is configured in relation to the fill level in the reservoir container (5).

The present invention relates to a device for stirring and for dosing the mixing ratio of various kinds of liquid, in particular of paints and a thinning agent, comprising a stirring rod and a reservoir container in which the liquids to be mixed together are filled, and a stirring rod for use in the device.

A stirring rod of this kind is disclosed in U.S. Pat. No. 4,574,621, which comprises a handle area and a measuring area for measuring the viscosity of liquids, which is used at the same time for mixing the liquids together. The measuring area is characterized by having a V-shaped slot worked into the end of the stirring rod. A measuring scale is printed on the side next to the V-shaped slot in order to allow the viscosity of the liquids filled in the reservoir container to be measured after they have been mixed.

The geometric shape of the slot means that highly viscous liquid adheres even in the widest area of the slot, whereas liquids with a lower viscosity require the sides of the opposite edges of the slot to be closer together before they can adhere.

The V-shaped slot and the measuring scale therefore make it possible to determine the viscosity of a liquid comprising several components. This is required, for example, when spraying paints and varnishes or the like, because it is often the case that the paints to be applied have a viscosity which is appropriate for manual application using a brush, roller or the like and are consequently too thick for use with spray guns. In this case, the paint has to have a thinning agent added to it in order to reduce its viscosity so that paint mixed in this way can be sprayed by the spray gun.

It is a disadvantage of the stirring rod according to U.S. Pat. No. 4,574,621 that the measuring scale does not permit any reliable statement to be made regarding whether the added quantity of solvent is sufficient to achieve the correct viscosity in the thinned liquid. Indeed, the stirring rod has to be pulled out of the liquid following each filling procedure and mixing to make it is possible to see whether the viscosity is correct for processing the liquid.

Furthermore, the printed measuring scale is covered when the liquid is stirred, so that it can neither be read nor detected. The user of the stirring rod therefore has to remember what the measuring scale looks like and make a mental correlation between a particular area of the slot and the corresponding viscosity value in order to know whether the paint has achieved the spraying viscosity specified by the manufacturer of the spray gun. What is more, this stirring rod does not provide any information for the user regarding how much additional solvent has been added to the reservoir container.

DE 20 2005 020 437 U1 discloses a device for setting the mixing ratio in a paint container. The paint container has a conically tapering outer jacket surface. A template is provided in order to make a connection between the fill level inside the paint container and the amount of solvent to be added. This template is attached on the outside next to the paint container and it has its external shape adapted to the jacket surface of the paint container. Various measuring scales are printed on the outside of the template, thereby allowing the corresponding fill level currently inside the paint container to be correlated with the additionally filled volume of solvent.

As a result, the user can tell by means of the fill level what percentage of solvent needs to be filled additionally in relation to the amount of paint filled in the container.

It has proven to be a disadvantage with this state of the art that the user still requires a stirring rod for mixing liquids comprising different components, because the template is not suitable for stirring. A further feature of the state of the art is that the individual measuring scales are printed on the outside of the template and are arranged outside the paint container for measuring the fill level and the additional amount of solvent to be added, which represents a disadvantage because the user needs to fill the paint container at eye level otherwise it is not possible to see how the fill level is changing inside the paint container in relation to the measuring scale of the template.

The measuring template cannot be used with paint containers that do not have a transparent jacket surface. Once the mixing has finished, the thinned paint needs to be poured into another container, which leads to contamination and is a waste of paint.

The task of the present invention is therefore to develop a device and a stirring rod of the aforementioned types in such a way as to enable liquids consisting of several components to be mixed together at the same time as making it possible to determine what amount of liquid has been filled into the reservoir container in addition to the quantity of liquid that was in the reservoir container in the first place.

This task is achieved by the features described in the pre-characterising clauses of the patent claim 1, 2 or 16. The features of the characterising part of patent claims 1 and 2 can be combined with one another in order to achieve the task.

Further advantageous configurations of the invention are disclosed in the subordinated claims.

The dimension of the measuring openings, the measuring bodies and the measuring webs that extend in the direction of the lengthways axis of the stirring rod is adapted to the change in volume inside the reservoir container in such a way that, as the fill level inside the reservoir container rises, it is possible to read off exactly what additional percentage has been filled into the reservoir container, which means that the user can accurately adjust the mixing ratio of the liquids to be processed, because the manufacturer of the paint or of spray guns can specify for each paint to be worked with and with regard to the spraying device used what quantity of solvent should be used for the volume of paint in question.

The spatial arrangement of the measuring openings, measuring webs and measuring bodies also guarantees that it is possible to determine the fill level and the quantity of liquid filled in addition in a reliable and safe way, even when covered by paint, irrespective of whether the outer wall of the reservoir container happens to be transparent or opaque. These measuring openings worked into the stirring rod and the measuring bodies formed onto the stirring rod can be read and recognized clearly even from above, meaning that the change in fill height can be detected through the opening of the reservoir container. Furthermore, the thinned paint can be filled and mixed directly in the reservoir container that can be attached to the spray gun. This means no additional mixing container is required, and so there is no need to transfer the liquid into the reservoir container. Pre-contamination and paint waste due to spilling the liquid are therefore avoided.

The drawing shows a sample embodiment of a device in accordance with the present invention for stirring and for dosing the mixing ratio of liquids, with seven different embodiments of a stirring rod, the details of which are explained below. In the drawing,

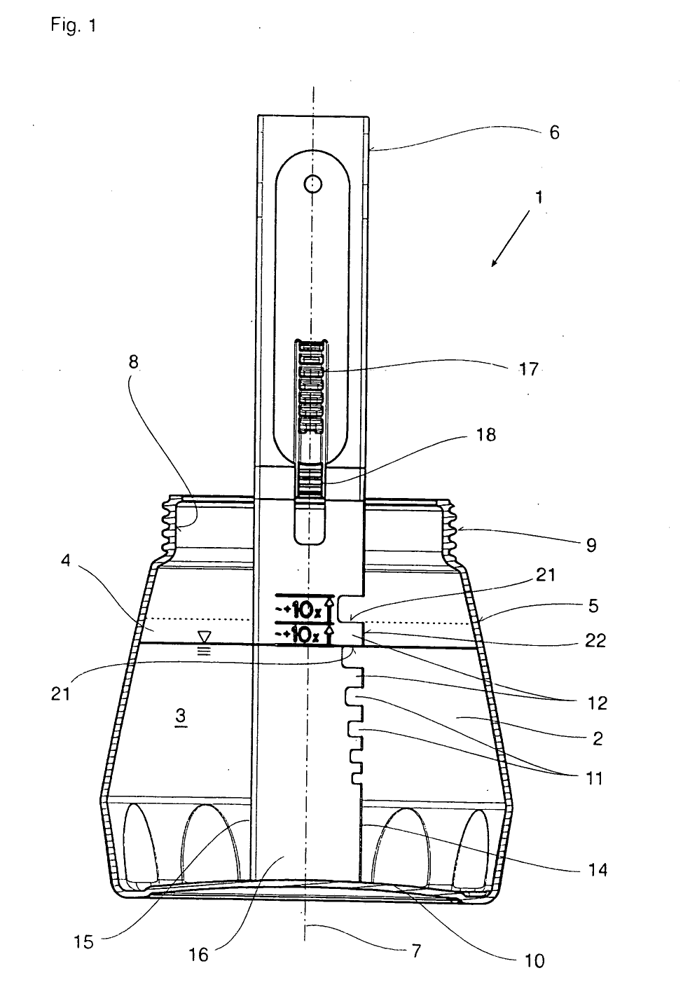

FIG. 1 shows a device comprising a reservoir container and a stirring rod inserted in it, in a first embodiment with six measuring openings and five measuring webs for establishing the fill level of the liquid filled in the reservoir container, in a sectional view from the front,

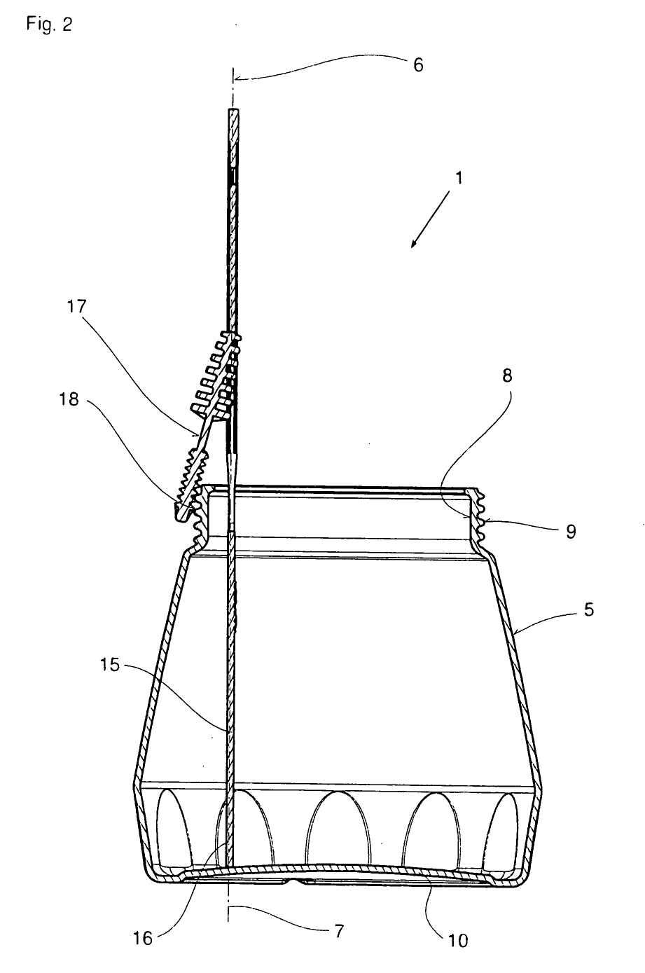

FIG. 2 shows the device in accordance with FIG. 1, from the side,

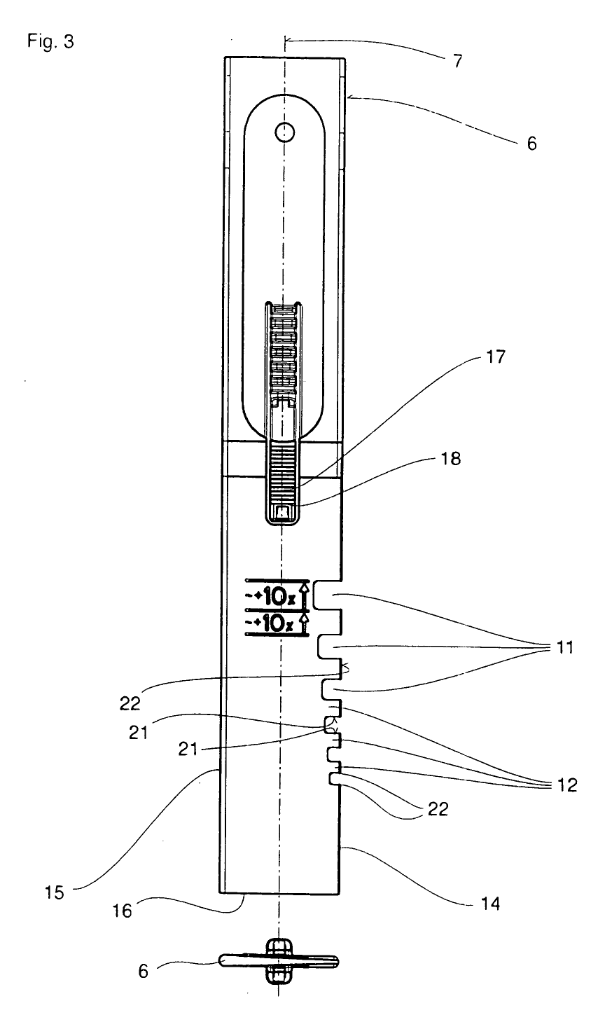

FIG. 3 shows the stirring rod in accordance with FIG. 1, from the front,

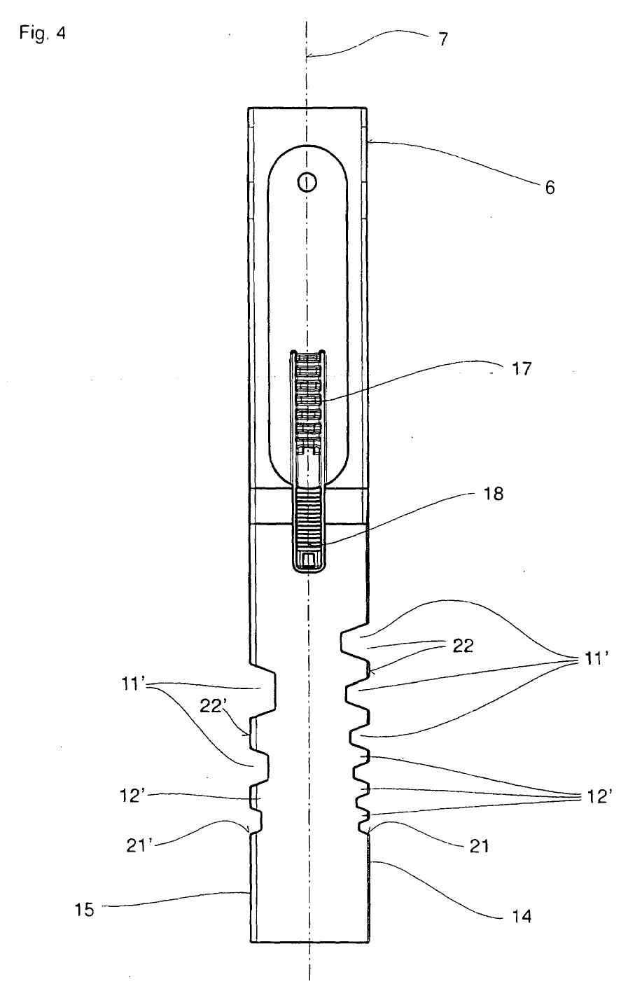

FIG. 4 shows a second embodiment of a stirring rod, with trapezoidally shaped measuring openings and measuring webs worked into both short sides,

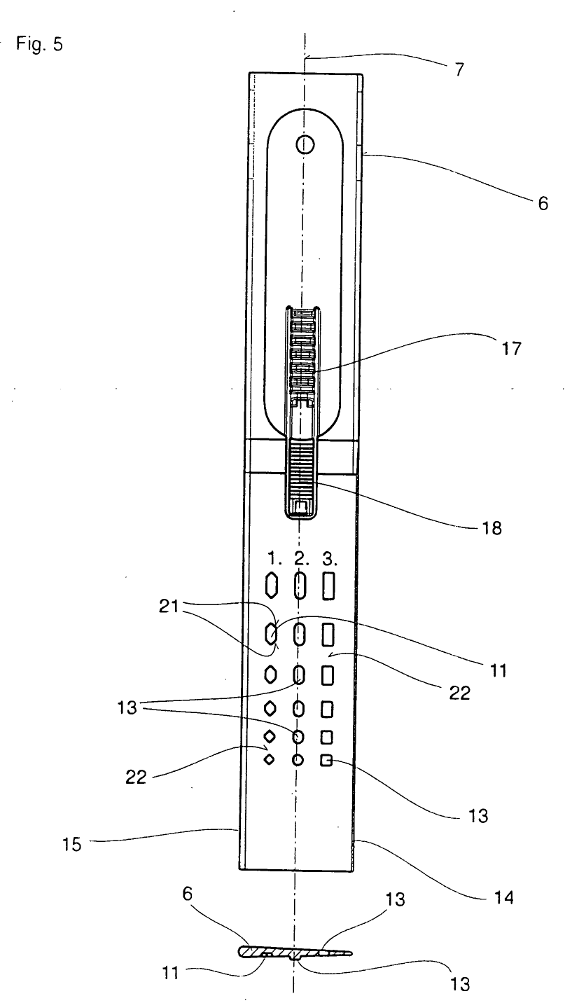

FIG. 5 shows a third embodiment of a stirring rod with measuring bodies formed onto it and measuring openings worked into it with a polygonal or elliptical geometrical shape, or with measuring bodes pressed onto it,

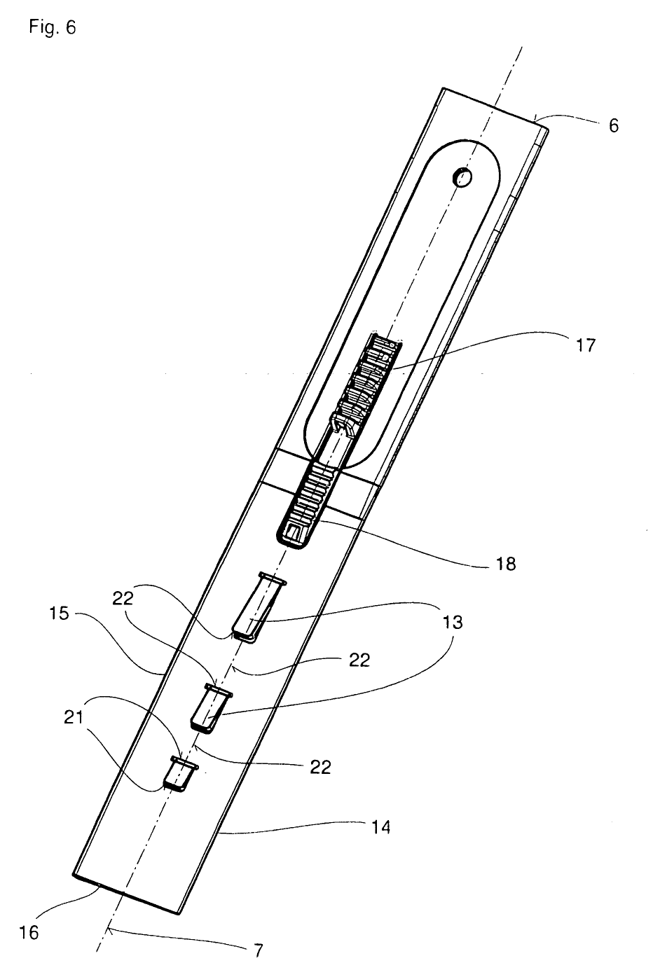

FIG. 6 shows a fourth embodiment of a stirring rod in a perspective view, with three measuring bodies formed onto it and attached to the stirring rod in a swivelling fashion, seen from the front,

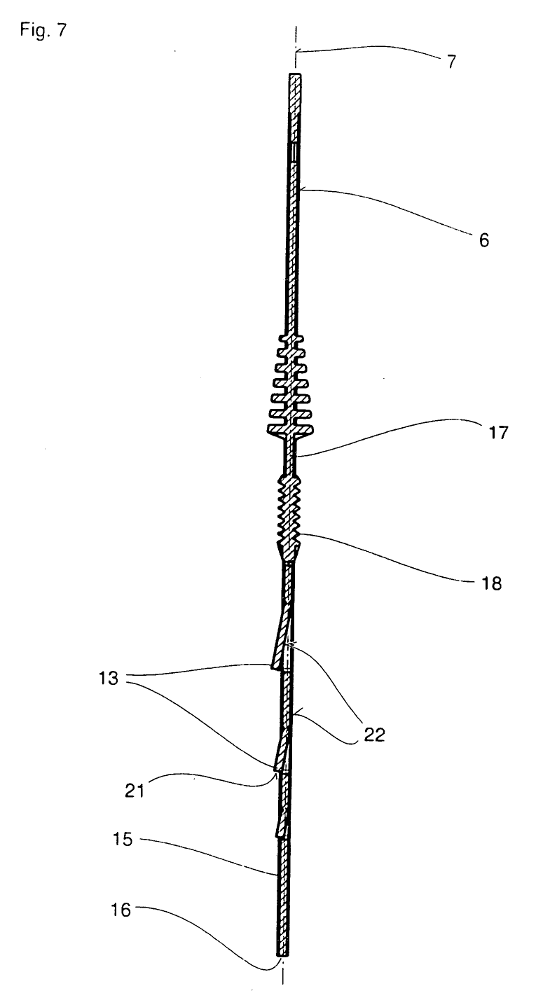

FIG. 7 shows the stirring rod in accordance with FIG. 6, in a sectional view,

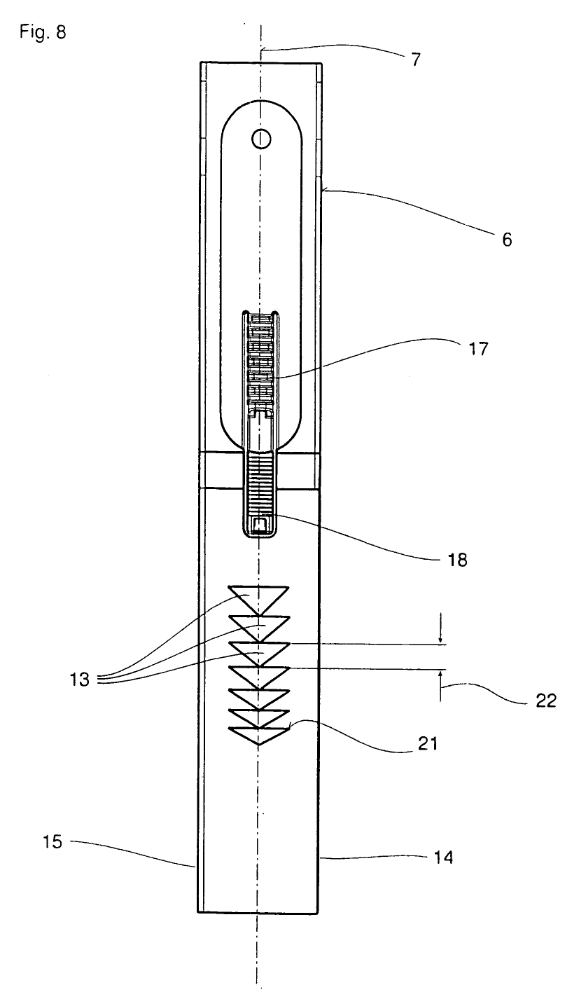

FIG. 8 shows a fifth embodiment of a stirring rod, with seven pyramid-shaped measuring bodies formed onto it, seen from the front,

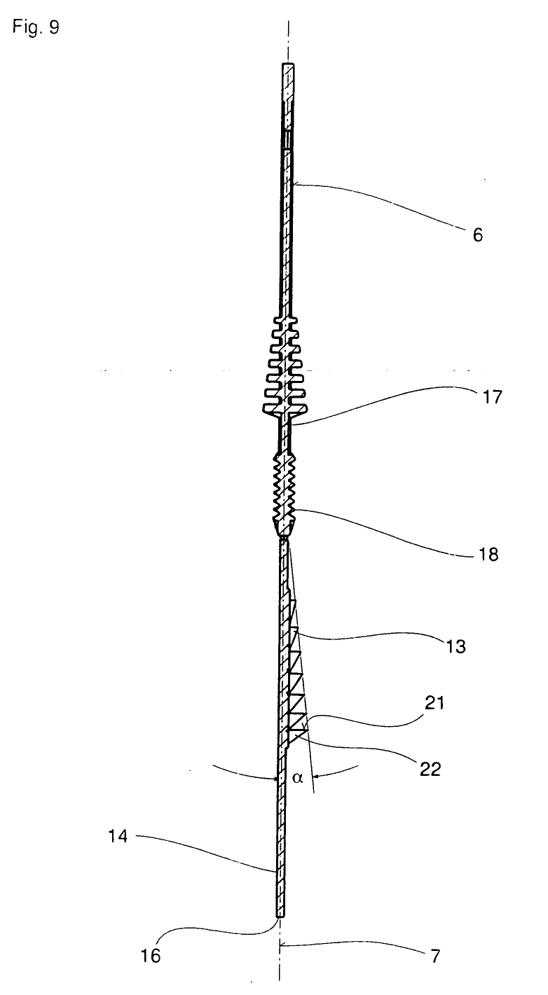

FIG. 9 shows the stirring rod in accordance with FIG. 8, in a sectional view,

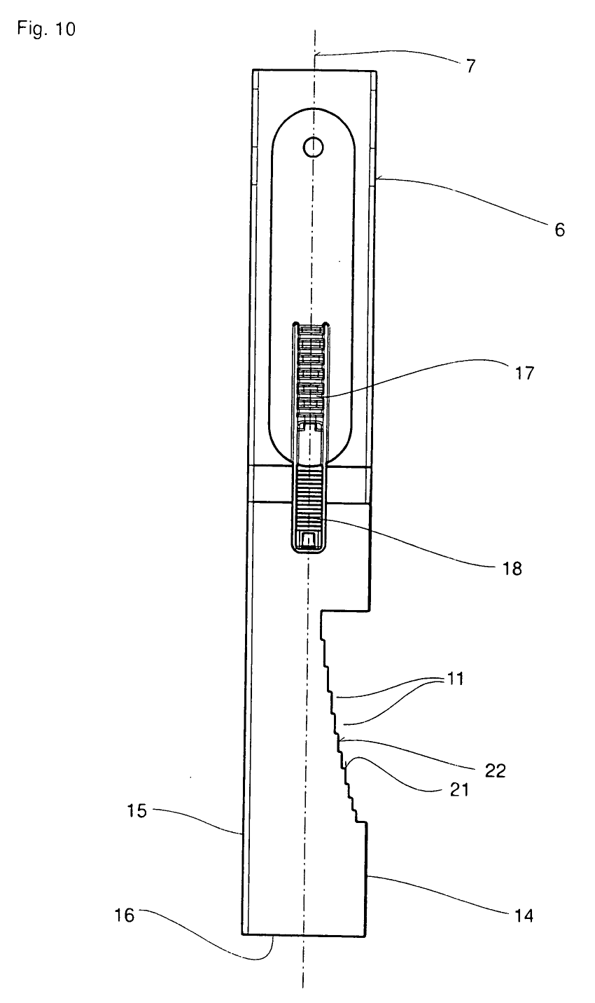

FIG. 10 shows a sixth embodiment of a stirring rod, with step-shaped measuring openings worked into one of its narrow sides, and

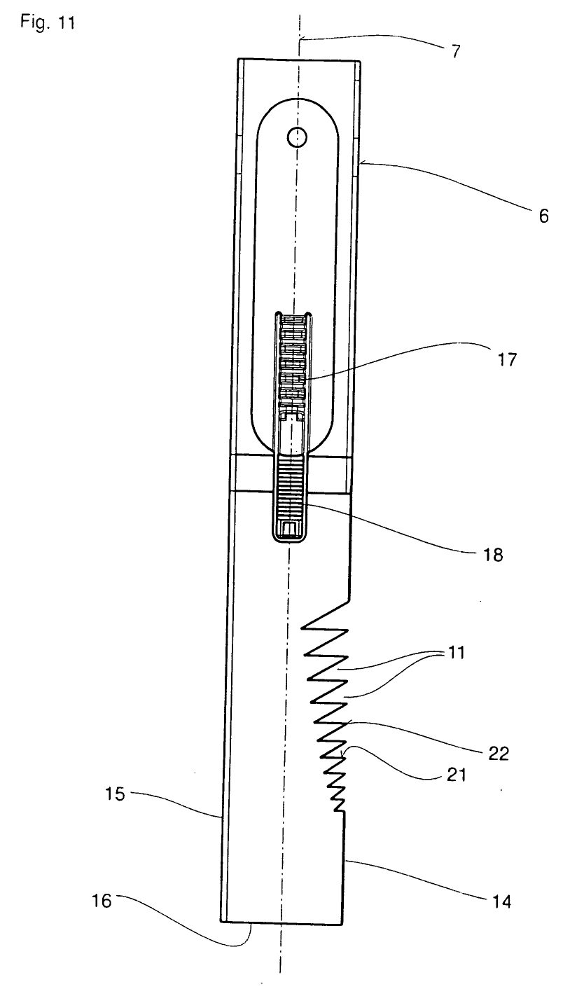

FIG. 11 shows a seventh embodiment of a stirring rod, with saw tooth-shaped measuring openings worked into one of its narrow sides.

The device 1 shown in FIGS. 1 and 2 consists of a reservoir container 5 and a stirring rod 6. The reservoir container 5 serves to hold liquids 2, namely paint 3 and a thinning agent 4, which are mixed together using the stirring rod 6. Once the liquids 2 have been mixed together, the reservoir container 5 can be connected by an external thread 9 to a spray gun (not illustrated) so that the liquids 2 can be applied to walls, ceilings and other structures and surfaces of objects by means of the spray gun.

Often, the paint 3 available in shops is intended for manual application using brushes, rollers or the like and cannot be processed using a spray gun. This is because if the paint 3 is used with a spray gun, its viscosity can result in the nozzle of the spray gun becoming blocked, so that the paint 3 cannot be applied optimally to the surfaces that are to be processed and painted using the spray gun. Retail outlets and manufacturers of spray guns have been aware of this problem for many years, and measuring beakers, measuring cups, etc. are provided which bear indications showing the dilution ratio in which the thinning agent 4, e.g. water, must be added to the paint 3 in order to obtain optimum processing of the liquids 2 using the spray gun.

To allow the liquids 2 to be mixed together using the stirring rod 6 and so that the mixing ratio to be achieved using the stirring rod 6 in one operation, the stirring rod 6 shown in FIGS. 1 to 3 has six measuring openings 11 worked into a narrow side 14 of the stirring rod 6. A rectangular measuring web 12 is provided between each pair of adjacent measuring openings 11. The rectangular measuring openings 11 are flush with and parallel to the lengthways axis 7 of the stirring rod 6. Each edge of the measuring rod 12 running horizontally—i.e. at right angles to the lengthways axis 7 of the stirring rod 6—can therefore be regarded as a measuring flank 21. In accordance with FIG. 1, the level of the liquid 2 is brought into line with one of the available measuring flanks 21. The vertical distance between two adjacent measuring flanks 21 can be regarded as the measuring distance 22, the dimension of which is in a percentage-based or linear relationship with the change in volume of the reservoir container 5. This means that the measuring distance 22 in the sample embodiment and FIGS. 1 to 3 corresponds to a 10% increase in the amount of liquid 2 in the container 5.

The stirring rod 6 is inserted in a filler opening 8 worked into the reservoir container 5 and is in contact with the base 10 of the reservoir container 5. The measuring distance 22 of the measuring openings 11 and the measuring webs 12 running parallel to the lengthways axis 7 of the stirring rod 6 is configured so as to be in a percentage-based relationship with the increase in the level of liquid in the reservoir container 5.

This is represented schematically because the paint 3 filled in the reservoir container 5 is now to be supplemented by a thinning agent 4. In the fill level of the paint 3 illustrated, it is assumed that an initial increase in the volume by 10% will be sufficient to opening a liquid 2 that can be processed optimally using the spray gun. In this case, the distance between the measuring flanks 21 is adapted to the reservoir container 5 in such a way as to take account of the fact that the inner contour tapers towards the filler opening 8. Each of the measuring distances 22 between two measuring flanks 21 of the measuring webs 12 therefore corresponds a 10% increase in the fill level inside the reservoir container 5.

Irrespective of what amount of paint 3 is initially container in the reservoir container 5, the user is able to determine with precision, from the outside or from above through the inlet opening 8, how the stirring rod must be positioned in order to achieve a correlation between the level of the liquid 2 and one of the measuring flanks 21, and how much additional thinning agent 4 must be added in order to thin the existing paint 3 by 10%. The measuring distance 22 between the measuring flanks 21 of the measuring openings 11 and the measuring webs 12 can be varied in order to make it possible to increase the fill level by 5%, 20% or the like.

FIG. 2 shows that a locking web 17 is formed on the stirring rod 6 in a pivoting arrangement located in the area of the inlet opening 8 of the reservoir container 5. There is a plurality of holding lugs 18 worked onto the free end of the locking web 17, which combine to form fluting and run at right angles to the lengthways axis 7 of the stirring rod 6. The locking web 17 can thus be reliably attached to the external thread 9 of the reservoir container 5 by means of the holding webs 18, with the effect that the stirring rod 6 is supported on the reservoir container 5. The legs projecting at right angles from the locking web 17 exclusively serve to allow the locking web 17 to be pushed out of the plane formed by the stirring rod 6 in order to lock it onto or release it from the reservoir container 5.

FIG. 3 additionally shows the geometrical shape of the cross section of the stirring rod 6 along its lengthways axis 7, because the narrow side designated 14 in which the measuring openings 11 and the measuring webs 12 are worked has a larger width than the narrow side 15 opposite to it.

FIG. 4 shows that trapezoidally shaped measuring openings 11′ and measuring webs 12′ are worked into both narrow sides 14 and 15. The measuring openings 11′ and 12′ that are opposite to one another in the narrow sides 14 and 15 are arranged offset from one another in the direction of the lengthways axis 7 of the stirring rod 6, although as before they do run in parallel with the lengthways axis 7, with the effect that the fill level changes inside the reservoir container 5 can be detected along the two narrow sides 14 and 15 of the stirring rod 6 according to the amount of paint 3 and thinning agent 4 filled.

The trapezoidal configuration of the measuring openings 11 and the measuring webs 12 makes it easier for the user to read off the height of the fill level, because the orientation of the measuring flanks 21 running at an angle to the plane of the horizontal means it is possible to establish with greater precision what the current fill level is and what additional amount of thinning agent 4 must be filled into the reservoir container 5, because the inclined measuring flanks 21 are covered more slowly than would be the case if they were horizontal. The measuring flanks 21 assigned to the narrow side 14 have a measuring distance of 10% and the measuring flanks 21 worked into the narrow side 15 have a measuring distance 22 of 20%.

FIG. 5 shows that measuring openings 11 with different geometrical configurations can be worked into the jacket surface of the stirring rod 6. Furthermore, it is specified there that measuring bodies 13 projecting from the plane of the stirring rod 6 are formed onto the rod 6. The geometrical shape of the measuring openings 11 or of the measuring bodies 13 in this case is selected so that the user can clearly read off the fill level inside the reservoir container 5, because the measuring openings 11 or the measuring bodies 13 form the measuring distance 22 and their upper and lower measuring flanks 21 serve as a reference point for the change in volume.

The first row of measuring openings 11 in this case has a hexagonal structure; a slot is terminated by two angled edges running towards one another. This geometrical shape means the user can read off the fill level exactly in this area, since the smaller the visible surface between the two edges running towards one another, the smaller the amount of thinning agent 4 that needs to be filled in order to achieve the desired mixing ratio for the fill level in question.

The same thing applies to the elliptical configuration of the second row of measuring bodies 13. The third row is provided with rectangular measuring bodies 13 that are pressed onto the surface of the stirring rod 6. These three differently configured rows can be provided all together or individually on the surface of a stirring rod 6.

FIG. 6 shows a stirring rod 6 with three measuring bodies 13 that are articulated in a swivelling arrangement on the stirring rod 6, with the effect that they are forced away from the corresponding opening in the stirring rod 6 in order to determine the fill level, with the effect that they project from the surface of the stirring rod 6 at an angle. The geometrical dimensions of each measuring body 13 in this case correlates to a certain percentage-based filling amount inside the reservoir container 5 and can be regarded as a measuring distance 22. Also, the distance between two adjacent measuring bodies 14 corresponds to a correspondingly specified increase in the fill level inside the reservoir container 5; as a result, each of the three measuring bodies 13 forms two measuring flanks 21 spaced apart from one another, which can be used as an orientation line for the change in volume.

FIG. 7 in particular shows that the measuring bodies 13 can be folded back into the plane of the stirring rod 6, for example in order to allow paint 3 and thinning agent 4 to be cleaned off the stirring rod 6 in the area of the measuring bodies 13 in a straightforward manner.

The measuring bodies 13 shown in FIGS. 8 and 9 are pyramid-shaped. FIG. 9 in particular shows that the measuring body 13 facing the end 16 of the stirring rod 6 is larger in size perpendicular to the lengthways axis 7 than the measuring body 13 facing the opening 8 in the reservoir container 5. The measuring bodies 13 arranged between these outer measuring bodies 13 feature a geometrical distance from the plane of the stirring rod 6, in which case this plane is located between the vertical dimension formed by the two outer measuring bodies 13. This means the measuring flanks 21 of the measuring bodies 13 projecting outwards lie along on the same line which describes an angle to the plane of the stirring rod 6. Consequently, each measuring body 13 represents a measure for the percentage-based measuring distance 22.

As a result, when the user inserts the stirring rod 6 through the inlet opening 8 and immerses it into the liquids 2, he or she is able to determine which measuring body 13 is covered by the existing fill level and which measuring body 13 will be the next one to be immersed in the liquids 2 as and when thinning agent 4 is added. In this case, the vertical dimension of the relevant measuring bodies 13 that runs in the lengthways direction 7 once again corresponds to a particular percentage-based increase in the fill level inside the reservoir container 5.

FIG. 10 shows that a measuring opening with a stepped shape is worked into the narrow side 14 of the stirring rod 6. Each step of this profile can be used as a measuring flank 21 in order to determine the level and the change in volume. The height of each particular step corresponds to the measuring distance 22. The course of the measuring opening 11 in the direction of the lengthways axis 7 means that the fill level changes can be detected from above without further ado.

The embodiment of the measuring opening 11 shown in FIG. 11 has a saw-toothed shape and is angled in relation to the lengthways axis 7 so that changes in the fill level can be read off from above. The individual teeth also form a measuring flank 21 which can be used as a suitable line for orientating the level. There is a percentage-based ratio between the distance between two adjacent measuring flanks 21 and the measuring distance 22.

1. An assembly (1) for stirring and for dosing a mixing ratio of liquids (2), in particular paints and a thinning agent, the assembly comprising a stirring rod (6), and a reservoir container (5) in which the liquids (2) to be mixed together are filled, wherein said stirring rod (6) is provided with at least two measuring openings (11) therein, the openings being spaced apart in the direction of a lengthways axis (7) of said stirring rod (6), wherein a dimension of the particular measuring opening (11) measured parallel to the lengthways axis (7), and a measuring web (12) remaining between two adjacent ones of the measuring openings (11), are configured in relation to a fill level of the liquids (2) that are put into said reservoir container (5).

2. An assembly (1) for stirring and for dosing a mixing ratio of liquids (2), in particular paints and a thinning agent, the assembly comprising a stirring rod (6) and a reservoir container (5) in which the liquids (2) to be mixed together are filled, wherein at least one surface of said stirring rod (6) is provided with one or more measuring bodies (13) formed thereon and which are spaced from one another in the direction of a lengthways axis (7) of said stirring rod (6) and in relation to a fill level in said reservoir container (5), and the dimension of the measuring bodies (13) running in the direction of the lengthways axis (7) of said stirring rod (6) is configured in relation to a fill level in said reservoir container (5).

3. The assembly in accordance with claim 2, wherein the measuring bodies (13) each have measuring flanks (21) spaced apart from one another, and adapted to be used as a means of orientation when determining a level inside said reservoir container (5).

4. The assembly in accordance with claim 1, wherein the measuring openings (11) are configured as notches in at least one of opposite narrow sides (14, 15) of said stirring rod (6), the measuring web (12) is provided between two adjacent openings (11) in one of the narrow sides (14 or 15) and the height of the measuring openings (11) running in the direction of the lengthways axis (7) of said stirring rod and of the measuring webs (12) is configured in accordance with the fill level reached in said reservoir container (5), and serves as a measurement value for the amount of additional liquid (2) added to said reservoir container (5).

5. The assembly in accordance with claim 4, wherein a measuring scale formed by the measuring openings (11) and the measuring webs corresponds to an increase in the fill level in said reservoir container (5) by a selected volume for each measuring opening (11).

6. The assembly in accordance with claim 4, wherein the measuring openings (11) in the narrow side (14, 15) of said stirring rod (6) have a stepped or saw-tooth shape running in the direction of the lengthways axis (7) of the said stirring rod (6).

7. The assembly in accordance with claim 6, wherein the measuring scale formed by the measuring openings (11) is aligned at an angle in relation to the lengthways axis (7) of said stirring rod (6), and the measuring webs (12) are configured as measuring flanks (21) that are angled outwards.

8. The assembly in accordance with claim 2, wherein the measuring bodies (13) are arranged immediately adjacent to and flush with one another and the measuring body facing a base (10) of said reservoir container (5) perpendicular to the lengthways axis of said stirring rod is larger than the measuring body facing an opening of said reservoir container, and that the measuring bodies (13) arranged between two outer measuring bodies (13) have their spatial arrangement at right angles to the lengthways axis (7) of said stirring rod (6) adapted to the spatial arrangement of the two outermost measuring bodies (13) such that the highest projections on the particular measuring bodies (13) run in a line oriented at an angle to the lengthways axis (7) of said stirring rod (6).

9. The assembly in accordance with claim 2, wherein the measuring bodies (13) are articulated on said stirring rod (6) in order to pivot and can be folded outwards out of a plane formed by said stirring rod (6).

10. The assembly in accordance with claim 1, wherein the measuring openings (11) and the measuring webs (12) are a selected one of rectangular, triangular, square and elliptical in shape.

11. The assembly in accordance with claim 2, wherein the measuring bodies (13) are a selected one of block-shaped and pyramid-shaped.

12. The assembly in accordance with claim 1, wherein a selected one of the measuring openings (11), the measuring webs (12) and measuring bodies (13) run in parallel to the lengthways axis (7) of said stirring rod (6) and flush with one another, and distances between the measuring webs (12), the measuring openings (11) and the measuring bodies (13) and/or their particular surface area dimensions are proportionately adapted to a change in volume inside the reservoir container (5).

13. The assembly in accordance with claim 1, wherein said stirring rod (6) is provided with a locking web (17) formed onto it, which locking web can be folded away from said stirring rod (6) and can be clipped onto said reservoir container (5) in order to fix the said stirring rod (6) in the reservoir container (5).

14. The assembly in accordance with claim 13, wherein a plurality of retaining webs (18) are disposed on the locking web (17) in the form of fluting, running at right angles to the lengthways axis (7) of said stirring rod (6), and one of the retaining webs (18) is adapted to be fixed into an external thread (9) in the outer jacket surface of said reservoir container (5) in the form of an undercut.

15. The assembly in accordance with claim 3, wherein said stirring rod (6) is in contact with a base (10) of said reservoir container (5) when said stirring rod is installed, or stirring rod (6) can be positioned on the reservoir container (5) in such a way that the measuring flank (21) is aligned flush with the level of the liquid (2).

16. A stirring rod (6) for use in an assembly for mixing liquids, wherein the stirring rod (6) is provided with at least two measuring openings (11) therein, which openings are spaced apart in the direction of a lengthways axis (7) of the stirring rod (6), and the dimension of a particular measuring opening (11) measured parallel to the lengthways axis (7), and a measuring web (12) between the two adjacent measuring openings (11), are configured in relation to a fill level of the liquids that are put into a reservoir container (5), or at least one surface of the stirring rod (6) is provided with one or more measuring bodies (13) formed, thereon and which are spaced at intervals from one another in the direction of the lengthways axis (7) of the stirring rod (6) and in relation to the fill level in the reservoir container (5), and that the dimension of the measuring bodies (13) running in the direction of the lengthways axis (7) of the stirring rod (6) is configured in relation to a fill level in the reservoir container (5).
